(19) United States
(12) Patent Application Publication
(10) Pub. No.: US 2004/0046691 A1
(43) Pub. Date: Mar. 11, 2004

(54) Method for optimizing spacecraft yaw pointing to minimize geometric pointing error in antenna systems

(76) Inventors: Lee A. Barker, San Jose, CA (US); Xenophon H. Price, Redwood City, CA (US)

Correspondence Address: J. E. Kosinski, Loral Space & Communications, Ltd., Suite 303, 655 Deep Valley Drive, Rolling Hills Estates, CA, 90274, US

(21) Appl. No.: 10/225,972

(22) Filed: Aug. 22, 2002

(51) Int. Cl. H04B 7/185

(52) U.S. Cl. 342/355; 342/358

(57) ABSTRACT

Payload performance is optimized by determining yaw trajectory employing a method which develops a mathematical expression to define the payload in terms of ‘n’ location(s) on the earth; determining the pointing error of the ‘n’ location(s); combining the error so as to product a single performance parameter and minimizing the value of the performance parameter by appropriately varying yaw.

### BACKGROUND

1. Field of Invention

This invention relates to spacecraft attitude control and more generally to steering yaw to point the payload optimally.

Under optimal conditions, conventional geosynchronous spacecraft are designed to operate at zero yaw optimally. However, orbital perturbation e.g., inclination eccentricity, causes target yaw to vary from zero. These variations from zero yaw have been a continuing problem in the proper pointing of spacecraft.

2. Prior Art

Prior art approaches to resolving this problem include U.S. Pat. No. 6,154,692 to Cielaszyk et al, assigned to the assignee of the present invention, which solve the problem with yaw as recited above, when the payload is aimed at the equator and/or directly over it. Various other systems and methodologies have been employed to resolve this problem.

In U.S. Pat. No. 6,154,692 a novel system is disclosed for controlling yaw angle deviations from a desired yaw angle profile. Other prior art systems have likewise attempted to accomplish this goal. However, nowhere in the prior art is the system of the instant invention disclosed relating to optimization of the desired yaw angle profile.

### OBJECTS OF INVENTION

It is therefore an object of this invention to provide a superior attitude control system including an optimal yaw pointing trajectory.

Another object of the instant invention is to provide a unique attitude control system that employs superior yaw pointing trajectory fully implementable in software.

It is a further object of this invention to overcome the above recited deficiencies in the prior art to provide an attitude control system with significantly improved yaw pointing trajectory.

This and other objects are accomplished by employing the system of the instant invention comprising choosing a yaw trajectory to yield the best performance for a given payload.

### SUMMARY OF THE INVENTION

More specifically the yaw trajectory is chosen to optimize payload performance employing the system of the instant invention comprising:

a) developing a mathematical expression that defines the payload in terms of ‘n’ location(s) on the earth

b) determining the pointing error(s) for the ‘n’ location(s)

c) combining the error(s) to produce a single performance parameter

d) and minimizing the value of the performance parameter by appropriately varying yaw.

The mathematical expression that defines the payload for ‘n’ location(s) on the earth is expressed by:

$${θ}_{Design} = {Sin}^{- 1} ( \frac{( {R}_{{E}_{Lat}} Cos ( {δ}_{Trgt} ) \cdot Sin ( Δ λ ) )}{( \sqrt{{( {R}_{{E}_{Lat}} Cos ( {δ}_{Trgt} ) )}^{2} + {r}_{Design}^{2} - 2 {r}_{Design} {R}_{{E}_{Lat}} Cos ( {δ}_{Trgt} ) Cos ( Δ λ )} )} )$$

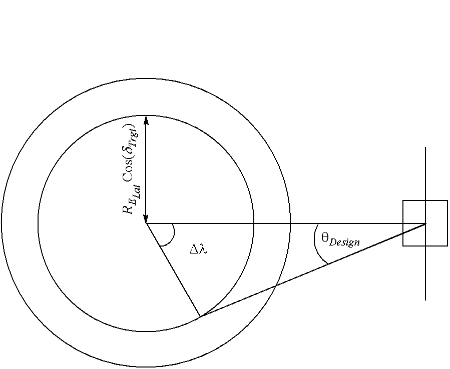

where R_{E}_{_{Lat}} is the radius of the Earth at the target geocentric latitude.

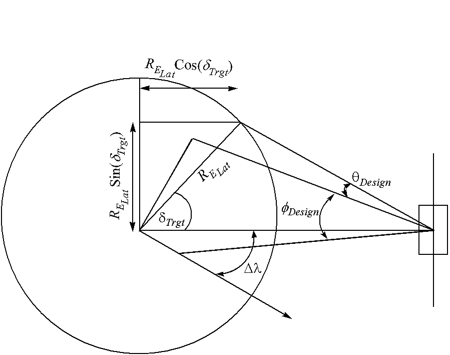

$${φ}_{Design} = {Sin}^{- 1} ( \frac{Sin ( {δ}_{Trgt} )}{\sqrt{{( \frac{Cos ( {δ}_{Trgt} ) Sin ( Δ λ )}{Sin ( {θ}_{Design} )} )}^{2} + {Sin}^{2} ( {δ}_{Trgt} )}} )$$

Definition of the terms:

Where θ_{Design} is the design pitch angle

Where r_{Design} is the geosynchronous radius

Where Δλ is the target offset longitude

Where δ_{Trgt} is the target geocentric latitude

Where θ_{Design} is the design elevation or roll angle.

### BRIEF DESCRIPTION OF THE DRAWINGS

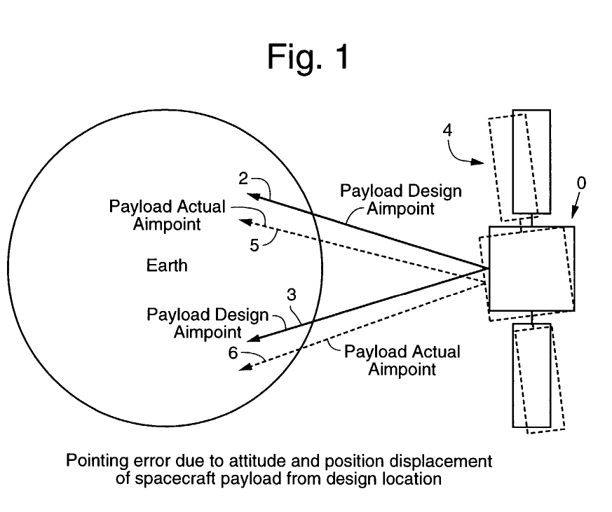

In FIG. 1 there is seen a diagramatic representation of a geosynchronous spacecraft which is experiencing perturbation generally from the Earth's gravitational pull in addition to lesser perturbation from the moon and the sun respectively.

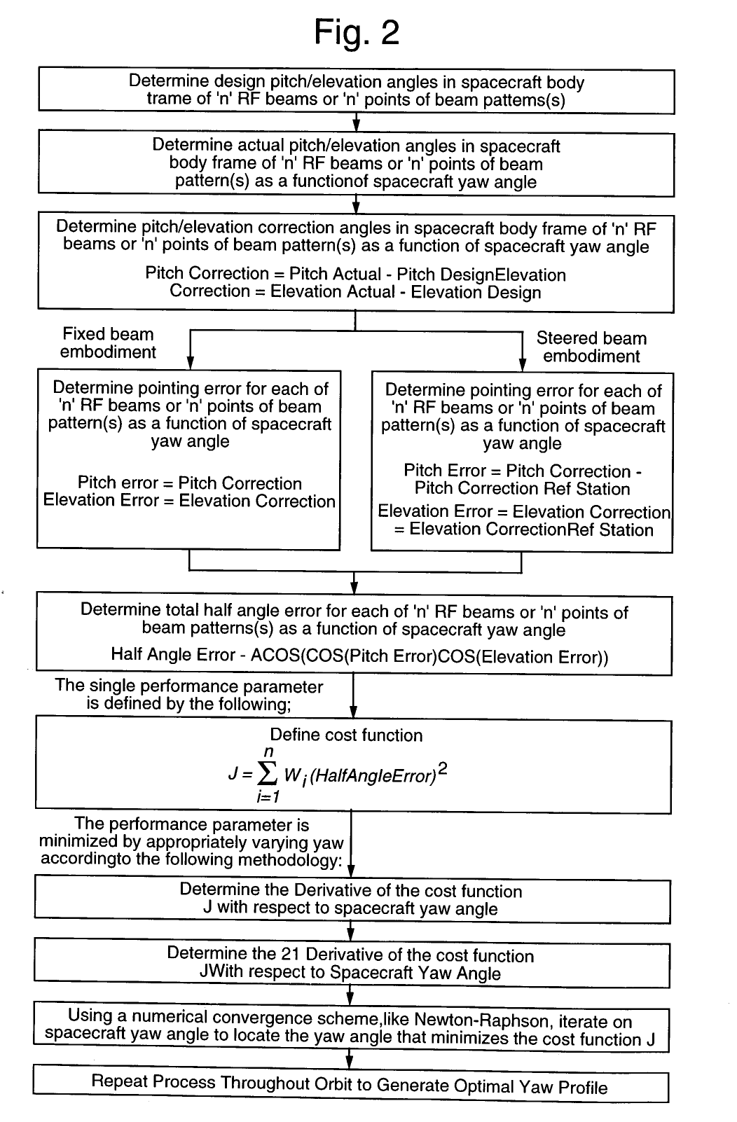

In FIG. 2 there is seen a block diagram of the method of the instant invention.

The spacecraft designated as (1) is seen to be positioned over the equator and to have aim points (2) and (3) which represent a system employing the invention. The dotted figures generally designated (4) is seen to have aim points (5) and (6) which are inappropriately offset to result in data rate inefficiencies.

In FIG. 2 the steps for the method of the instant invention are outlined in block form for two embodiments; one directed to the fixed beam embodiment, which follows down the left hand path of the block diagram and; the other for the steered beam embodiment which follows down the right hand path. Each block is appropriately described with regard to the step of the method embraced. This block diagram is outlined step by step for both paths in the instant specification under Detailed Description of the Invention starting of pages 5 and proceeding on through page 7.

### DETAILED DESCRIPTION

More specifically the system of the instant invention may be employed e.g., as follows in two illustrative embodiments, the first directed to employing fixed antennas comprising the steps of:

Step A: Determine design pitch/elevation angles in spacecraft body frame of ‘n’ RF beams or ‘n’ points of beam pattern(s).

Step B: Estimate initial yaw (zero yaw angle or ‘yaw north’) as appropriate starting points'.

Step C: Determine actual pitch/elevation angles in spacecraft body frame of ‘n’ RF beams or ‘n’ points of beam pattern(s) as a function of spacecraft yaw angle.

Step D: Determine pitch/elevation correction angles in spacecraft body frame of ‘n’ RF beams or ‘n’ points of beam pattern(s) as a function of spacecraft yaw angle (pitch correction=pitch actual−pitch design; elevation correction=elevation actual−elevation design).

Step E: Determine pointing error for each of ‘n’ RF beams or ‘n’ points of beam pattern(s) as a function of spacecraft yaw angle (pitch error=pitch correction−pitch correction ref station; elevation error=elevation correction elevation correction ref station).

Step F: Determine total half angle error for each of ‘n’ RF beams or ‘n’ points of beam pattern(s) as a function of spacecraft yaw angle (half angle error=ACOS(COS(pitch error)COS(elevation error)).

Step G: Define Cost Function;

$$J = {\sum }_{i = 1}^{n} {{W}_{i} ( HalfAngleError )}^{2}$$

=JflalJAngletrror)

Step H: Determine the derivative of the cost function J with respect to spacecraft yaw angle.

Step I: Determine the 2^{nd} derivative of the cost function J with respect to spacecraft yaw angle.

Step J: Using a numerical convergence scheme, like Newton-Raphson, iterate on spacecraft yaw angle to locate the yaw angle that minimizes the cost function J.

Converge.

Step K: Repeat process throughout orbit to generate optimal yaw profile.

In an alternate embodiment employing Auto Track, the instant invention may be employed, for example, as follows:

Step 1: Determine design pitch/elevation angles in spacecraft body frame of ‘n’ RF beams or ‘n’ points of beam pattern(s).

Step 2: Estimate initial yaw (zero yaw angle or ‘yaw north’) as appropriate starting points'.

Step 3: Determine actual pitch/elevation angles in spacecraft body frame of ‘n’ RF beams or ‘n’ points of beam pattern(s) as a function of spacecraft yaw angle.

Step 4: Determine pitch/elevation correction angles in spacecraft body frame of ‘n’ RF beams or ‘n’ points of beam pattern(s) as a function of spacecraft yaw angle (pitch correction=pitch actual−pitch design; elevation correction=elevation actual−elevation design).

Step 5: Determine pointing error for each of ‘n’ RF beams or ‘n’ points of beam pattern(s) as a function of spacecraft yaw angle (pitch error=pitch correction; elevation error=elevation correction).

Step 6: Determine total half angle error for each of ‘n’ RF beams or ‘n’ points of beam pattern(s) as a function of spacecraft yaw angle (half angle error=ACOS(COS(pitch error)COS(elevation error)).

Step 7: Define Cost Function;

$$J = {\sum }_{i = 1}^{n} {{W}_{i} ( HalfAngleError )}^{2}$$

Step 8: Determine the derivative of the cost function J with respect to spacecraft yaw angle.

Step 9: Determine the 2^{nd} derivative of the cost function J with respect to spacecraft yaw angle.

Step 10: Using a numerical convergence scheme, like Newton-Raphson, iterate on spacecraft yaw angle to locate the yaw angle that minimizes the cost function J.

Converge.

Step 11: Repeat process throughout orbit to generate optimal yaw profile.

Although the system of the instant invention has been described in terms of the specification, accompanying drawings and illustrative examples including the various methods by which it may be employed, other steps or subsystems may be employed without departing from the spirit of the instant invention. For example, the fixed beam embodiment as discussed above may be combined with the steered beam embodiment in various combinations to obtain the desired results. In addition, the cost function as used herein may be defined alternatively by beam polarization. The definition of the design pitch elevation angles and the actual pitch and elevation angle measurements may be further redefined or improved upon by different modeling techniques.

What is claimed is:

1) A method of employing a yaw trajectory to optimize payload performance in a satellite system comprising:
a) developing a mathematical expression that defines the payload in terms of “n” location(s) on the earth;
b) determining the pointing error(s) for the “n” location(s);
c) combining the error(s) to produce a single performance parameter and
d) minimizing the value of the performance parameter by appropriately varying yaw.

2) The method as defined in claim 1, wherein said “n” location(s) on the earth is defined by the expression:
$${θ}_{Design} = {Sin}^{- 1} ( \frac{( {R}_{{E}_{Lat}} Cos ( {δ}_{Trgt} ) \cdot Sin ( Δ λ ) )}{( \sqrt{{( {R}_{{E}_{Lat}} Cos ( {δ}_{Trgt} ) )}^{2} + {r}_{Design}^{2} - 2 {r}_{Design} {R}_{{E}_{Lat}} Cos ( {δ}_{Trgt} ) Cos ( Δ λ )} )} )$$
where R_{E}_{_{Lat}} is the radius of the Earth at the target geocentric latitude.
Where r_{Design} is the geosynchronous radius.
Where Δλ is the target offset longitude.
Where δ_{Trgt} is the target geocentric latitude.

3) The method as defined in claim 1, wherein said Step A comprises determining design pitch/elevation angles in spacecraft body frame of ‘n’ RF beams or ‘n’ points of beam pattern(s).

4) The system is defined in claim 1, wherein said Step B comprises: determining the actual pitch/elevation angles in spacecraft body frame of ‘n’ RF beams or ‘n’ points of beam pattern(s) as a function of spacecraft yaw angle and determining pitch/elevation correction angles in spacecraft body frame of ‘n’ RF beams or ‘n’ points of beam pattern(s) as a function of spacecraft yaw angle.

5) The method as defined in claim 4 for application to fixed beams comprising: determining pointing error for each of ‘n’ RF beams or ‘n’ points of beam pattern(s) as a function of spacecraft yaw angle wherein pitch error equals pitch correction and elevation error equals elevation correction.

6) The method as defined in claim 4 as applied to autotrack slaved beams further comprising determining pointing error for each of ‘n’ RF beams or ‘n’ points of beam pattern(s) as a function of spacecraft yaw angle wherein pitch error equal pitch correction minus pitch correction reference stations and elevation error equals elevation correction minus elevation correction reference station.

7) The method as defined in claim 1 wherein Step B further comprises determining total half angle error for each of ‘n’ RF beams or ‘n’ points of beam pattern(s) as a function of spacecraft yaw angle wherein half angle error equals ACOS(COS(Pitch Error)COS(Elevation error).

8) The system as defined in claim 1 wherein said Step C comprises defining a cost function according to the expression
$$J = {\sum }_{i = 1}^{n} {{W}_{i} ( HalfAngleError )}^{2}$$

9) The system as defined in claim 1 wherein said Step D comprises determining the derivative of the cost function J with respect to the spacecraft yaw angle; determining the second derivative of the cost function J with respect to spacecraft yaw angle; and employing a numerical convergence scheme to minimize the cost function J.

10) The method as defined in claim 1 wherein Steps A through D are repeated throughout the orbit of the satellite to generate optimal yaw profile.
